(19) United States
(12) Patent Application Publication
(10) Pub. No.: US 2017/0162997 A1
(43) Pub. Date: Jun. 8, 2017

(54) METHOD FOR MANUFACTURING TERMINAL FITTING WITH ELECTRIC WIRE

(71) Applicant: YAZAKI CORPORATION, Tokyo (JP)

(72) Inventor: Daisuke Miyakawa, Shizuoka (JP)

(21) Appl. No.: 15/364,795

(22) Filed: Nov. 30, 2016

(30) Foreign Application Priority Data
Dec. 2, 2015 (JP) 2015-235437

(51) Int. Cl. H01R 43/24; H01R 43/00; H01R 43/048; H01R 4/18

(52) U.S. Cl. CPC H01R 43/24; H01R 4/183; H01R 43/005; H01R 43/048

(57) ABSTRACT

A method for manufacturing a terminal fitting with an electric wire, includes forming a wire-terminal connection section by connecting a terminal fitting to an exposed conductor section of an electric wire in which a resin cover is removed from the electric wire to expose a conductor of the electric wire, supplying a sealing material from a nozzle of a dispenser to the wire-terminal connection section to form a sealing section that covers the wire-terminal connection section. In a process of supplying the sealing material, after the supply of the sealing material by pushing of a piston of the dispenser is completed, the piston is retracted within a range of not allowing the sealing material to run down from the nozzle.

### CROSS REFERENCE TO RELATED APPLICATIONS

This application is based on Japanese Patent Application (No. 2015-235437) filed on Dec. 2, 2015, the contents of which are incorporated herein by reference. BACKGROUND OF THE INVENTION

1. Field of the Invention

The present invention relates to a method for manufacturing a terminal fitting with an electric wire in which a sealing section, such as an anti-corrosion section, is formed at a connection portion of dissimilar metals in the electric wire and the terminal fitting.

2. Description of the Related Art

For example, wire harnesses are routed in a vehicle to electrically connect devices mounted in the vehicle. A wire harness includes an electric wire bundle and various kinds of connectors disposed at the terminal ends of this electric wire bundle. Each of the connectors of the wire harness has an insulating connector housing and a plurality of conductive terminal fittings accommodated in the terminal accommodating chamber of this connector housing. The terminal fittings are disposed at the terminal ends of the electric wires constituting the electric wire bundle. A copper wire (the conductor thereof is composed of strands made of copper or a copper alloy) is generally used as an electric wire. The terminal end of this copper wire is stripped and then connected to a terminal fitting by crimping. The base material of the terminal fitting is made of copper or a copper alloy as in the case of the conductor of the copper wire and is plated in some cases.

In recent years, aluminum wires are sometimes used instead of copper wires in consideration of the reduction in the weight of a vehicle and the easiness of material recycling in addition to the shortage in copper resources (an electric wire having a conductor made of aluminum or an aluminum alloy is referred to as an aluminum wire in this specification). However, it is known that the oxide coating film formed on the surface of the aluminum serving as the material of the conductor of the aluminum wire is thicker than that of the copper serving as the material of the conductor of the copper wire. It is also known that the contact resistance between the conductor and the terminal fitting (crimp terminal) in the aluminum wire tends to become relatively high. Hence, a method for raising compressibility by strongly caulking the conductor with a pair of conductor caulking pieces formed on the crimp terminal is adopted to reduce the contact resistance between the conductor of the aluminum wire and the crimp terminal. With this method, the oxide coating films of the respective strands constituting the conductor can be broken by strongly caulking the conductor of the aluminum wire. In other words, the contact resistance between the conductor and the crimp terminal can be reduced.

However, it is known that if moisture intervenes in the contact portion between the aluminum material and the copper material, in other words, in the contact portion between the dissimilar metals, both the metals, aluminum and copper, are dissolved as ions, a potential difference, for example, is generated therebetween, and electrolytic corrosion occurs. In the case that the conductor of the aluminum wire is connected to the crimp terminal made of copper or a copper alloy electrically and mechanically, since high compression crimping is performed at the portion where the conductor is crimped with the conductor caulking pieces of the crimp terminal, moisture intrusion is prevented, and as a result, the occurrence of electrolytic corrosion is avoided. However, since some portions of the conductor are in a state of being exposed at some positions along the crimped portion of the conductor crimped with the conductor caulking pieces in the direction of the terminal axis (in the extending direction of the electric wire), if moisture attaches to such portions and then reaches the above-mentioned crimped portion, the crimped portion is, as it were, in a state of being immersed in an electrolytic solution, whereby there is a danger that the aluminum, a metal having the larger ionization tendency, may be dissolved and electrolytic corrosion may progress. Hence, such anti-corrosion sections 115 (sealing sections) as shown in FIGS. 9A and 9B are formed conventionally to prevent moisture from attaching to the exposed portions of the conductor and from intruding into the crimped portion (for example, refer to JP-A-2011-113708 described below).

In FIGS. 9A and 9B, the reference numeral 101 designates an aluminum wire and the reference numeral 102 designates a crimp terminal. The aluminum wire 101 is composed of a conductor 103 made of aluminum or an aluminum alloy and an insulating resin cover 104 for covering this conductor 103. An exposed conductor section 105 is formed by removing the end section of the resin cover 104 of the aluminum wire 101. On the other hand, the crimp terminal 102 serving as a female terminal fitting is formed into the shape shown in the figure by pressing a metal plate made of copper or a copper alloy. The crimp terminal 102 has an electric contact section 106 having a rectangular cylindrical shape, a caulking section 107, and a connection section 108 for connecting the electric contact section 106 and the caulking section 107. A mounting section 109 for allowing the exposed conductor section 105 to be mounted thereon, a conductor caulking piece 110 for caulking the exposed conductor section 105 mounted on this mounting section 109 and a cover caulking piece 111 for caulking the resin cover 104 in the vicinity of the exposed conductor section 105 are formed in the caulking section 107.

In the above-mentioned configuration and structure, a wire-terminal connection section 118 is formed so as to include a conductor caulking portion 112 in which the exposed conductor section 105 is caulked with the conductor caulking piece 110 and a cover caulking portion 113 in which the resin cover 104 in the vicinity of the exposed conductor section 105 is caulked with the cover caulking piece 111. In the conductor caulking portion 112, however, non-caulking portions 114 are generated due to the relationship between the length of the exposed conductor section 105 and the width of the conductor caulking piece 110. Hence, in the wire-terminal connection section 118, the anti-corrosion sections 115 (sealing sections) are formed in a state of covering these non-caulking portions 114. The anti-corrosion sections 115 are formed by dripping an anti-corrosion material 117 (sealing material) from each of the respective nozzles 116 of two dispensers and by curing the anti-corrosion material 117 applied by the dripping. Silicone rubber is adopted as the anti-corrosion material 117.

In the above-mentioned conventional technology, the anti-corrosion material 117 (sealing material) is dripped from each of the nozzles 116 of the two dispensers and the anti-corrosion material 117 applied by the dripping is cured, whereby the anti-corrosion sections 115 are formed. However, in the conventional forming method, there is a danger that the anti-corrosion material 117 may run down from the respective nozzles 116. In such a case, it is necessary to wipe off the anti-corrosion material 117 from the tip ends of the respective nozzles 116 after the application, thereby causing a problem of low workability. In addition, a problem of material loss also occurs because the anti-corrosion material 117 is wiped off.

Not only in the case that running down has occurred as described above but also even in the case that liquid buildup (wetting-up) has occurred at the tip ends of the nozzles 116, wiping work is necessary (the state of liquid buildup will be explained briefly in the descriptions of the embodiments). In addition, the supply amount of the anti-corrosion material 117 becomes unstable due to liquid buildup.

### SUMMARY OF THE INVENTION

The present invention has been made in consideration of the above-mentioned circumstances and is intended to provide a method for manufacturing a terminal fitting with an electric wire capable of improving workability and reducing material loss.

A method for manufacturing a terminal fitting with an electric wire, comprising:
forming a wire-terminal connection section by connecting a terminal fitting to an exposed conductor section of an electric wire in which a resin cover is removed from the electric wire to expose a conductor of the electric wire;
supplying a sealing material from a nozzle of a dispenser to the wire-terminal connection section to form a sealing section that covers the wire-terminal connection section,
wherein in a process of supplying the sealing material, after the supply of the sealing material by pushing of a piston of the dispenser is completed, the piston is retracted within a range of not allowing the sealing material to run down from the nozzle.

With the above method, after the supply of the sealing material is completed, the piston of the dispenser is retracted, whereby a suction action is exerted and the sealing material is prevented from running down.

With the above method, in the process of supplying the sealing material to the wire-terminal connection section, after the supply of the sealing material by the dispenser is completed, the piston of the dispenser is retracted to prevent the sealing material from running down, thereby eliminating the need for wiping work. Furthermore, since the need for wiping off the sealing material is eliminated, material loss does not occur. Hence, the present invention exhibits the advantages of being capable of improving workability and reducing material loss.

### BRIEF DESCRIPTION OF THE DRAWINGS

FIG. 1 is a perspective view showing a terminal fitting with an electric wire, illustrating a manufacturing method according to the present invention;

FIG. 2 is a cross-sectional view taken on line A-A of FIG. 1;

FIG. 3 is a perspective view showing the wire-equipped terminal before an anti-corrosion section is formed;

FIG. 4 is a cross-sectional view taken on line B-B of FIG. 3;

FIG. 5 is a view illustrating steps in the manufacturing method according to the present invention;

FIGS. 6A to 6C are views showing the dispenser shown in FIGS. 1 and 5; FIG. 6A is a view showing a state in which an anti-corrosion material is being supplied, FIG. 6B is a view showing a state after the supply of the anti-corrosion material is ended, and FIG. 6C is a view, taken as a comparative example, showing a state in which running down of the anti-corrosion material has occurred;

FIGS. 7A and 7B are views showing the dispenser shown in FIGS. 1 and 5; FIG. 7A is a view showing a state in which liquid buildup does not occur, and FIG. 7B is a view, taken as an comparative example, showing a state in which liquid buildup has occurred;

FIG. 8 is a view showing a modification of the dispenser; and FIGS. 9A and 9B are views showing the conventional wire-equipped terminal; FIG. 9A is a perspective view showing the wire-equipped terminal, and

FIG. 9B is a cross-sectional view taken on line D-D of FIG. 9A.

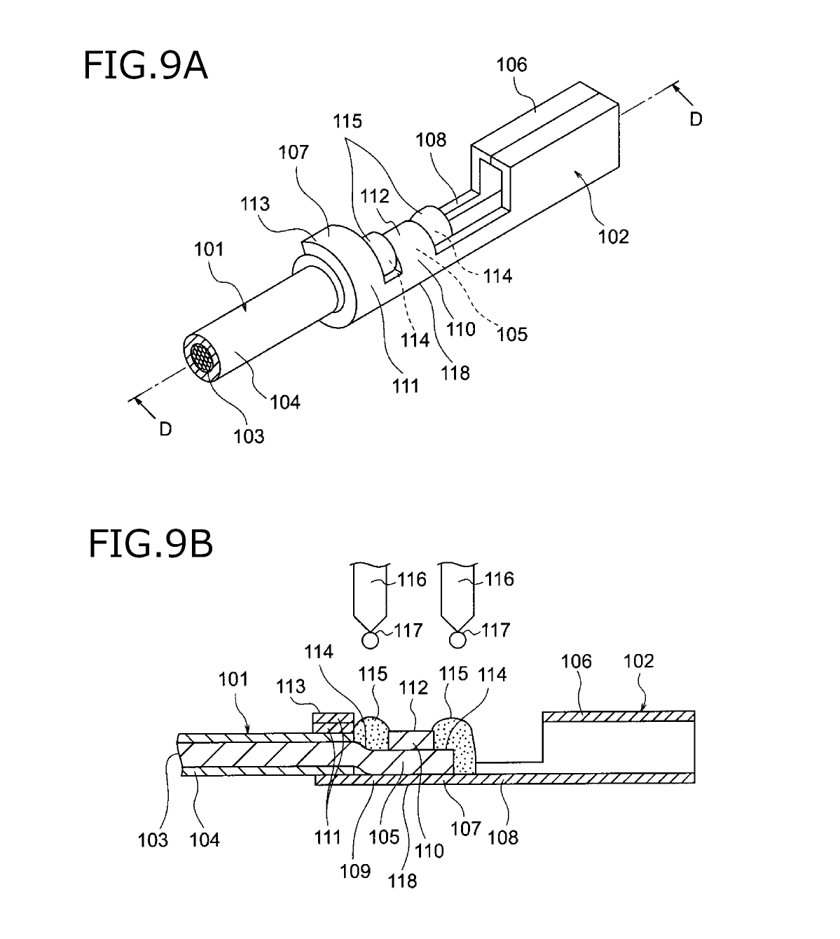

### DETAILED DESCRIPTION OF THE EXEMPLARY EMBODIMENTS

A terminal fitting with an electric wire includes an aluminum wire and a crimp terminal. The aluminum wire is composed of a conductor made of aluminum or an aluminum alloy and an insulating resin cover for covering this conductor. An exposed conductor section is formed by removing the resin cover of the aluminum wire. The crimp terminal has a caulking section serving as a crimping portion, and conductor caulking pieces and cover caulking pieces are formed at this caulking section. In the wire-equipped terminal, the caulking section is crimped to the exposed conductor section, whereby a wire-terminal connection section is formed. An anti-corrosion material is then supplied so as to cover the wire-terminal connection section (at an anti-corrosion material supplying step), and the anti-corrosion material is cured, whereby an anti-corrosion section is formed. At the anti-corrosion material supplying step, a dispenser for supplying the anti-corrosion material is used. After the supply of the anti-corrosion material by the pushing of the piston of the dispenser is ended, the piston is retracted within the range of not allowing the anti-corrosion material to run down from the nozzle.

### Embodiments

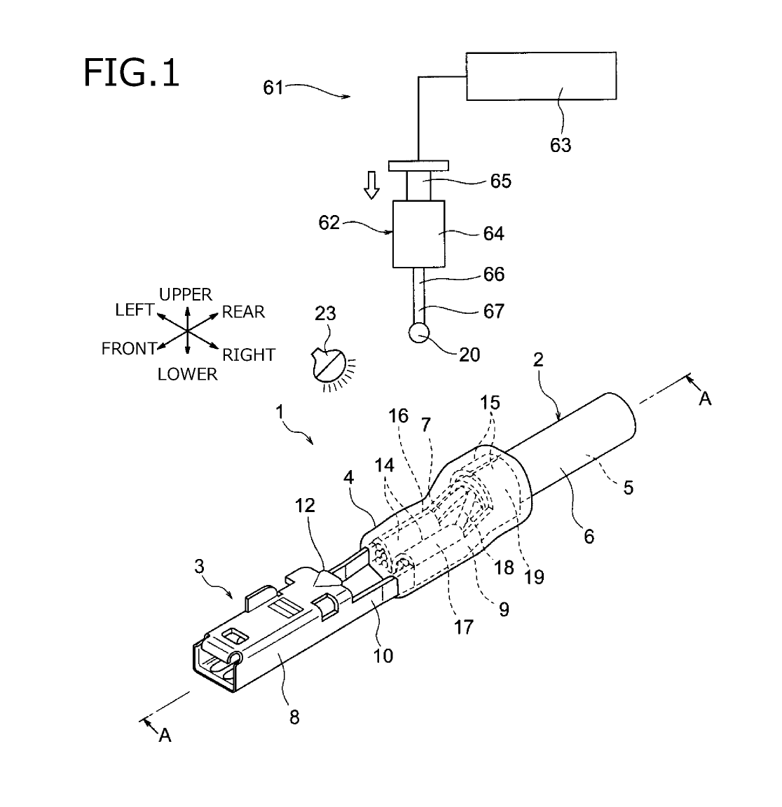

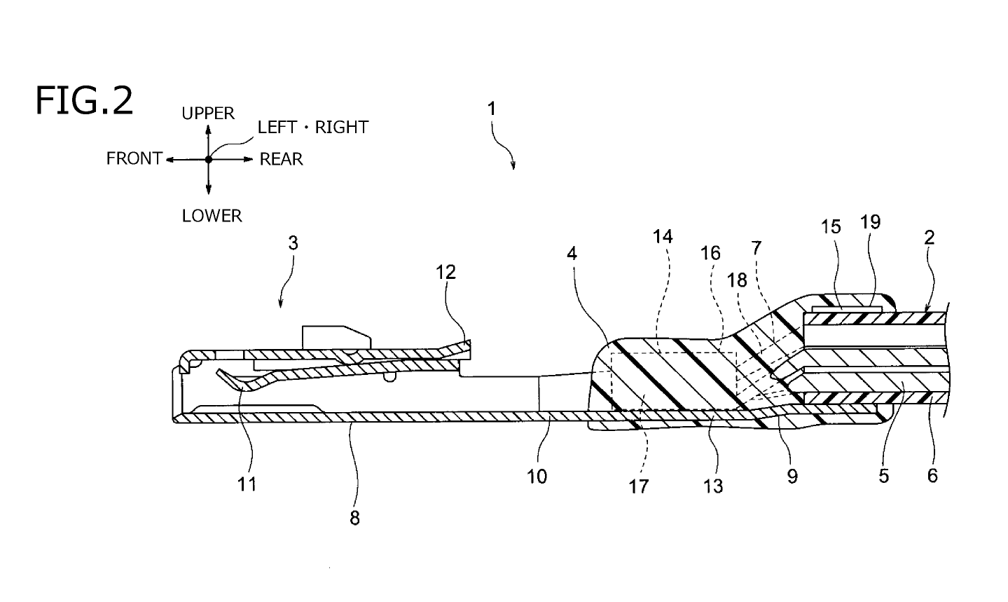

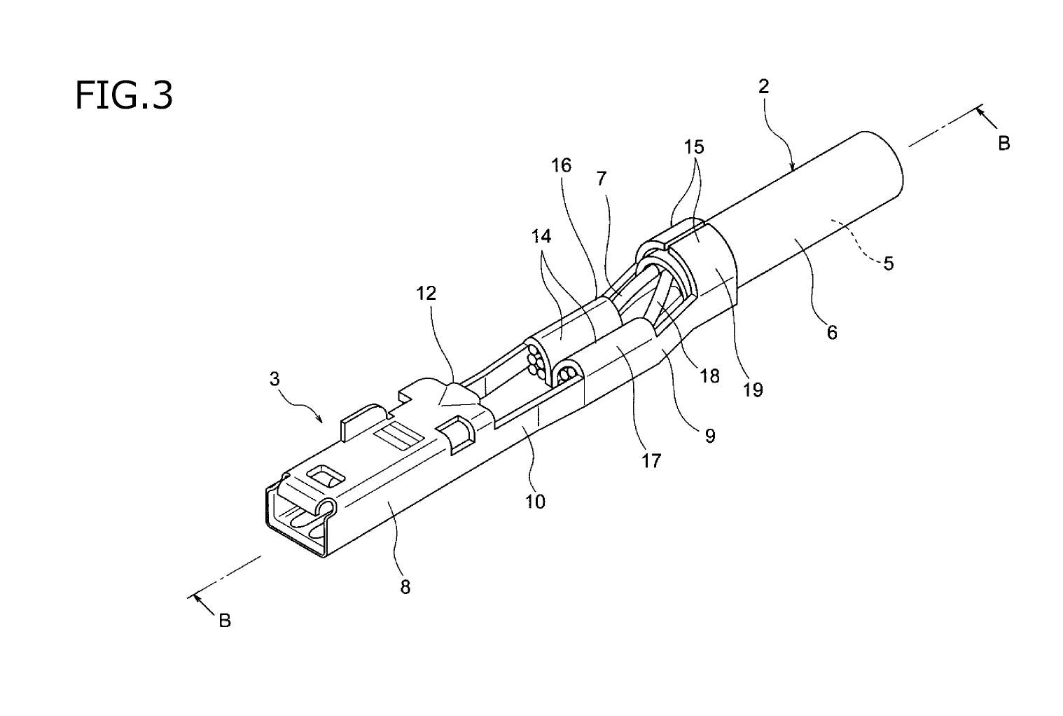

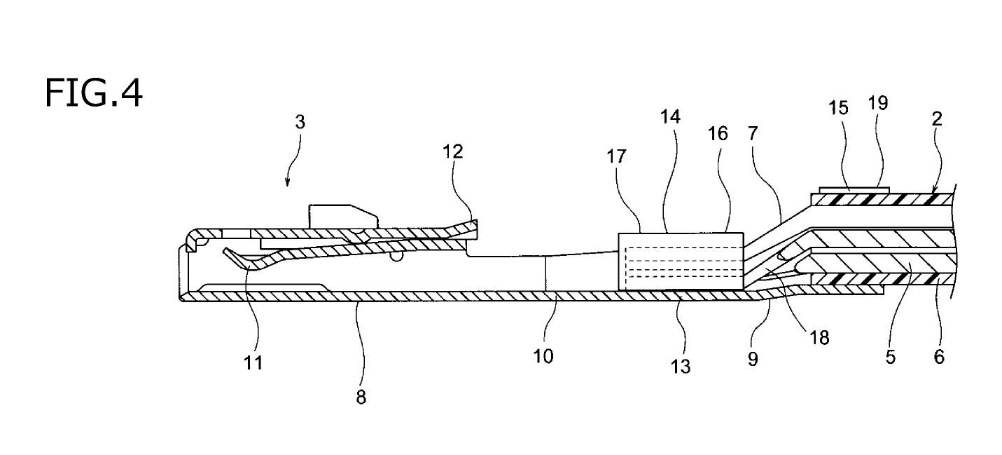

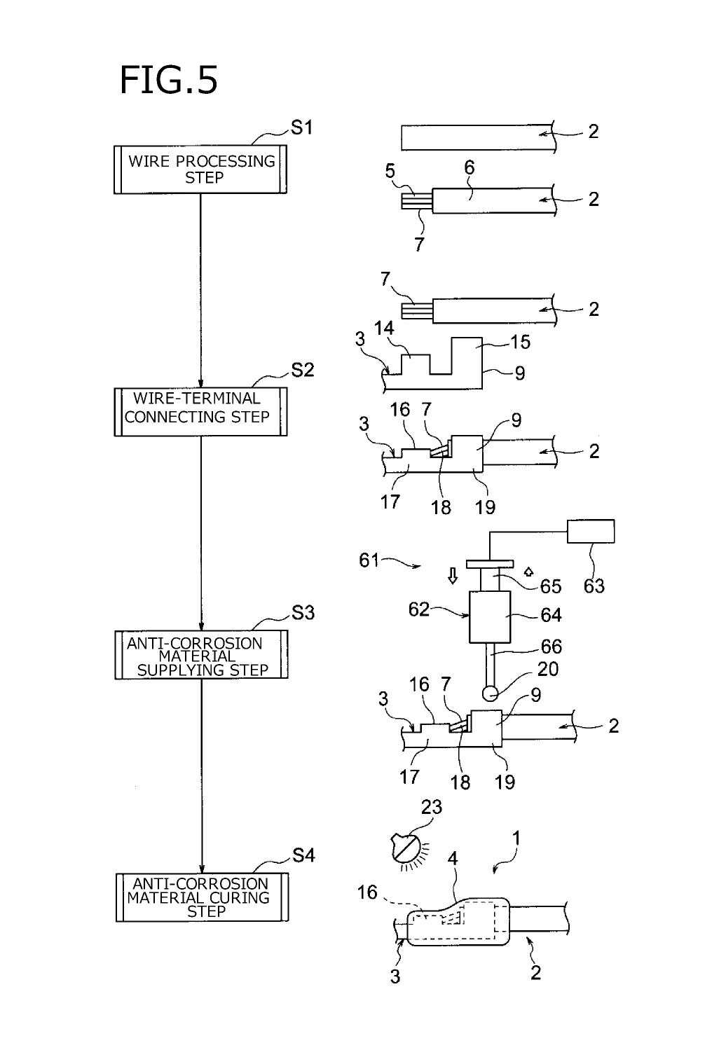

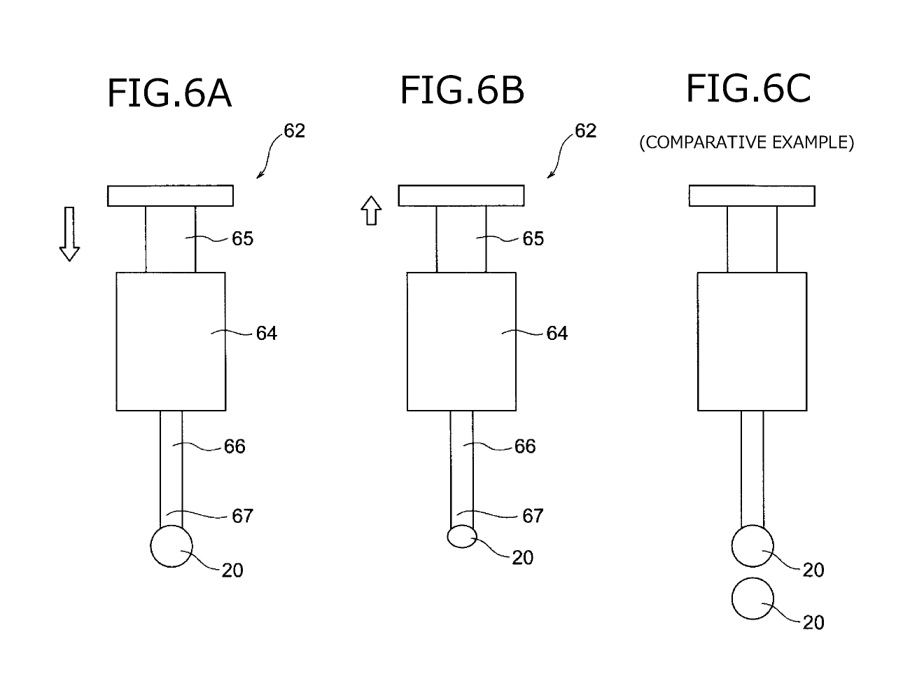

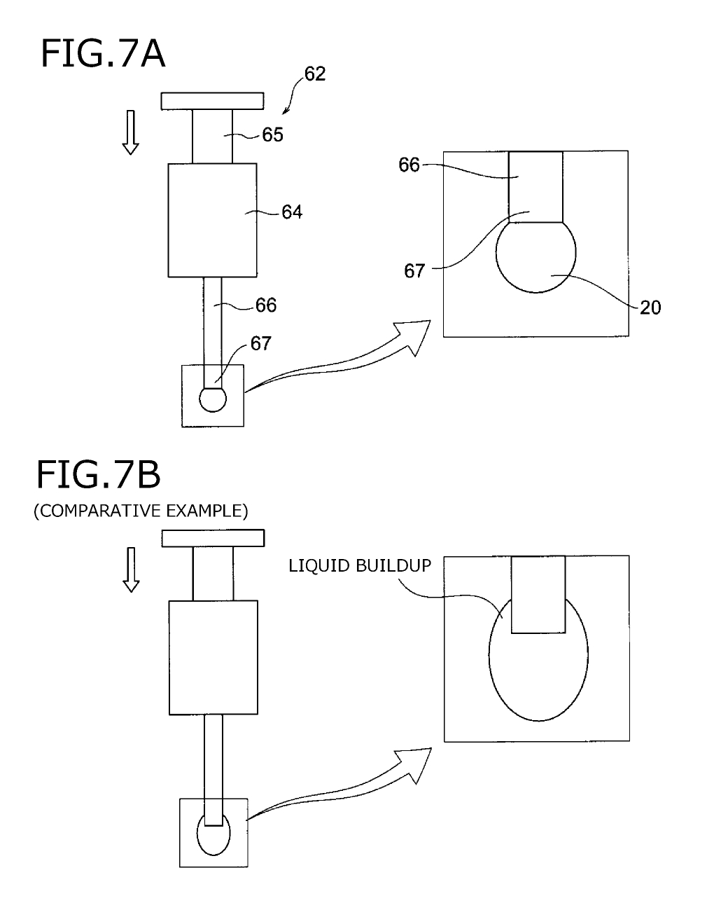

Embodiments will be described below referring to the accompanying drawings. FIG. 1 is a perspective view showing a terminal fitting with an electric wire, illustrating a manufacturing method according to the present invention. Furthermore, FIG. 2 is a cross-sectional view taken on line A-A of FIG. 1, FIG. 3 is a perspective view showing the wire-equipped terminal before an anti-corrosion section is formed, and FIG. 4 is a cross-sectional view taken on line B-B of FIG. 3. Moreover, FIG. 5 is a view illustrating steps in the manufacturing method according to the present invention, FIGS. 6A to 6C are views showing the dispenser shown in FIGS. 1 and 5; FIG. 6A is a view showing a state in which an anti-corrosion material is being supplied, FIG. 6B is a view showing a state after the supply of the anti-corrosion material is ended, and FIG. 6C is a view, taken as an comparative example, showing a state in which running down of the anti-corrosion material has occurred. Still further, FIGS. 7A and 7B are views showing the dispenser shown in FIGS. 1 and 5; FIG. 7A is a view showing a state in which liquid buildup does not occur, and FIG. 7B is a view, taken as an comparative example, showing a state in which liquid buildup has occurred.

### <Configuration of the Wire-Equipped Terminal 1>

In FIGS. 1 and 2, the reference numeral 1 designates a terminal fitting with an electric wire to be manufactured according to the present invention. The wire-equipped terminal 1 includes an aluminum wire 2 (electric wire) and a crimp terminal 3 (terminal fitting) disposed at the terminal end of this aluminum wire 2. Furthermore, the wire-equipped terminal 1 is configured so as to have an anti-corrosion section 4 (sealing section, waterproof section) at the connection portion of dissimilar metals in the aluminum wire 2 and the crimp terminal 3. Although the wire-equipped terminal 1 according to this embodiment is configured such that the crimp terminal 3 is disposed at the terminal end of the aluminum wire 2, it may be possible that, for example, a terminal fitting having an appropriate shape is disposed at an intermediate portion of the aluminum wire 2.

### <Configuration and Structure of the Aluminum Wire 2>

In FIGS. 1 to 4, the aluminum wire 2, having a circular cross-section and having flexibility such that, when a bending force is applied to the wire, a reaction force for returning the wire to its original state is generated, is adopted. The aluminum wire 2 has a conductor 5 and a resin cover 6.

The conductor 5 is formed by twisting a plurality of strands (not designated by numerals) each having a circular cross-section. The strands are made of aluminum or an aluminum alloy. In other words, the conductor 5 is made of aluminum or an aluminum alloy. The conductor 5 has a predetermined conductor cross-sectional area. In addition, the portion having this conductor cross-sectional area exists along the wire length of the aluminum wire 2. Since the specific gravity of aluminum is 2.70 g/cm³ and the specific gravity of copper to be described later is 8.96 g/cm³, the aluminum wire 2 is lighter in weight. In the case that the aluminum wire 2 is used as a long vehicle-mounted wire, it is effective, for example, in improving fuel consumption efficiency.

The standard electrode potential of aluminum in an electrochemical reaction is −1.676 V and the standard electrode potential of copper to be described later is +0.340 V. The difference between these potentials is large. Hence, if moisture intrudes and stays in the space between aluminum and copper, a battery is formed by aluminum, copper and an electrolyte aqueous solution. As a result, contact corrosion between dissimilar metals (galvanic corrosion, electrolytic corrosion) occurs at the anode of the battery, that is, the conductor 5. In consideration of this problem, the anti-corrosion section 4 for preventing the electrolytic corrosion is required as a matter of course.

The resin cover 6 is a so-called insulator and is formed on the outside of the conductor 5 into a circular cross-sectional shape by extrusion-molding a resin material having insulation property. Known various kinds of materials can be adopted as the above-mentioned resin material. The resin material is properly selected from, for example, polymer materials, such as polyvinyl chloride resin, polyethylene resin and polypropylene resin.

A predetermined length of the resin cover 6 is removed from the terminal end of the aluminum wire 2 configured as described above, whereby an exposed conductor section 7 is formed.

### <Structure of the Crimp Terminal 3>

In FIGS. 1 to 4, the crimp terminal 3 is a female terminal fitting and is formed into, for example, the shape shown in the figures by pressing a metal plate whose base material is made of copper or a copper alloy (the crimp terminal may be a male terminal fitting). The surface of the base material is supposed to be plated although not shown particularly in the figures. The plating is deposited between the copper and the aluminum serving as the contact portions of the dissimilar metals. The crimp terminal 3 has an electric contact section 8, a caulking section 9 and a connection section 10 for connecting the electric contact section 8 and the caulking section 9.

The electric contact section 8 is an electrical connection portion to be connected to a mating terminal fitting, not shown, and is formed into a cylindrical shape having a rectangular cross-section. An insertion space corresponding to the tab of the mating terminal fitting is formed inside the electric contact section 8. In addition, an elastic contact piece 11 that elastically makes contact with the tab when the tab is inserted is formed. In the electric contact section 8, the reference numeral 12 designates an engaged section that is hooked and engaged with the lance of a connector housing, not shown.

The caulking section 9 is a portion electrically connected to the aluminum wire 2 and is formed into a portion capable of being connected by crimping because the terminal fitting according to this embodiment is the crimp terminal 3. More specifically, the caulking section 9 is formed so as to have portions, that is, a mounting section 13 on which the exposed conductor section 7 of the aluminum wire 2 is mounted, a pair of conductor caulking pieces 14 for caulking the exposed conductor section 7 mounted on this mounting section 13, and a pair of cover caulking pieces 15 for caulking the resin cover 6 in the vicinity of the exposed conductor section 7. The mounting section 13 is also referred to as a bottom plate in some cases. In addition, the conductor caulking piece 14 is also referred to as a wire barrel in some cases. Furthermore, the cover caulking piece 15 is also referred to as an insulation barrel in some cases.

The pair of conductor caulking pieces 14 and the pair of cover caulking pieces 15 are disposed with a predetermined space provided therebetween in the axial direction of the terminal. Furthermore, both the pair of conductor caulking pieces 14 and the pair of cover caulking pieces 15 have a nearly V shape before caulking. Since the pair of conductor caulking pieces 14 is used to caulk the exposed conductor section 7 and the pair of cover caulking pieces 15 is used to caulk the resin cover 6, these are formed so as to have widths and protruding lengths being different depending on the differences in the shape and the outer circumferential length of an object to be caulked.

When the exposed conductor section 7 is crimped to the caulking section 9 configured as described above, a wire-terminal connection section designated by the reference numeral 16 is formed. The wire-terminal connection section 16 is formed so as to include a conductor caulking portion 17 for caulking the exposed conductor section 7 with the pair of conductor caulking pieces 14, a non-caulking portion 18 around this conductor caulking portion 17, and a cover caulking portion 19 for caulking the resin cover 6 in the vicinity of the exposed conductor section 7 with the pair of cover caulking pieces 15.

The connection section 10 is formed into a nearly trough shape extending in a predetermined length in the axial direction of the terminal. The electric contact section 8 is formed continuously to one end of the connection section 10 in the axial direction of the terminal. In addition, the caulking section 9 is formed continuously to the other end of the connection section 10 in the axial direction of the terminal.

### <Configuration of the Anti-Corrosion Section 4>

In FIGS. 1 and 2, the anti-corrosion section 4 is formed as a portion for water-tightly covering the wire-terminal connection section 16 to prevent electrolytic corrosion. More specifically, in the case that the arrows shown in the figures are defined to indicate the up-down, left-right and front-rear directions, the anti-corrosion section 4 is formed as a portion for covering the upper side of the caulking section 9 (the upper sides of the conductor caulking portion 17 and the non-caulking portion 18), the lower side of the caulking section 9 (the lower side of the mounting section 13), the left and right sides of the caulking section 9, the front side of the caulking section 9 (the front side of the conductor caulking portion 17) and the rear side of the cover caulking portion 19. In other words, the anti-corrosion section 4 is formed as a portion for covering the front and rear sides of the wire-terminal connection section 16 and the entire circumference of the wire-terminal connection section 16 in the axial direction of the terminal.

### <Method for Manufacturing the Wire-Equipped Terminal 1>

In FIG. 5, the wire-equipped terminal 1 is manufactured through the following steps. That is to say, the wire-equipped terminal 1 is manufactured through wire processing step S1, wire-terminal connecting step S2, anti-corrosion material supplying step S3 (sealing material supplying step, waterproof material supplying step) and anti-corrosion material curing step S4 in this order. The anti-corrosion material supplying step S3 and the anti-corrosion material curing step S4 are steps (forming method) for forming the anti-corrosion section 4.

At the wire processing step S1, the exposed conductor section 7 is formed at the terminal end of the aluminum wire 2. More specifically, the resin cover 6 is removed by a predetermined length to expose the conductor 5, whereby the exposed conductor section 7 is formed.

At the wire-terminal connecting step S2, the caulking section 9 of the crimp terminal 3 is disposed at the position of the exposed conductor section 7, and then crimp connection is performed to form the wire-terminal connection section 16. At the time of the crimping, pressing using the anvil and crimper of a crimping machine, that is, caulking, is performed. When the exposed conductor section 7 is crimped to the caulking section 9, the conductor caulking portion 17, the non-caulking portion 18 and the cover caulking portion 19 are formed are formed.

At the anti-corrosion material supplying step S3, an anti-corrosion material 20 (sealing material, waterproof material) is supplied to the wire-terminal connection section 16. At the anti-corrosion material supplying step S3, an anti-corrosion material supplying device 61 having the configuration described below is used. The anti-corrosion material supplying device 61 is configured so as to include a dispenser 62 and a controller 63 for controlling this dispenser 62 as shown in FIGS. 1 and 5. The dispenser 62 has a syringe 64, a piston 65 and a nozzle 66. In the dispenser 62 configured as described above, when the syringe 64 is filled with the anti-corrosion material 20 and the piston 65 is pushed downward under the control of the controller 63, a predetermined amount of the anti-corrosion material 20 drips from the nozzle 66. The anti-corrosion material 20 drips until it covers the wire-terminal connection section 16. In this embodiment, a liquid ultraviolet curing resin is adopted as the anti-corrosion material 20.

In the manufacturing method according to the present invention, after the supply of the anti-corrosion material 20 is ended, the piston 65 is retracted under the control of the controller 63 within the range of not allowing the sealing material 20 to run down from the nozzle 66. When the piston 65 is slightly retracted upward as shown in FIG. 6B, it is recognized according to the figure that the size of the ball of the anti-corrosion material 20 becomes small. Hence, such running down of the anti-corrosion material 20 as shown in FIG. 6C does not occur (such running down occurs in the case that a force for pushing out the anti-corrosion material 20 remains). Furthermore, in the manufacturing method according to the present invention, liquid buildup (wetting-up) of the anti-corrosion material 20 does not occur at the tip end of the nozzle 66 as shown in FIG. 7A (FIG. 7B shows a state in which liquid buildup has occurred). This is because the surface of the tip end of the nozzle 66 (or the entire surface of the nozzle) is subjected to water-repellent processing so as to have a water-repellent function (the water-repellent processing is not limited particularly, provided that the processing can provide the water-repellent function). (The reference numeral 67 designates a water-repellent processing section.)

In FIG. 5, at the anti-corrosion material curing step S4, ultraviolet light (UV light) is applied to the anti-corrosion material 20 having been supplied to the entire circumference of the wire-terminal connection section 16 to perform UV curing. Since the anti-corrosion material 20 is made of a liquid ultraviolet curing resin, the anti-corrosion material 20 is cured in a short time when the material receives the energy generated by the irradiation of the ultraviolet light from, for example, a UV light 23. When the anti-corrosion material 20 is cured, the formation of the anti-corrosion section 4 for water-tightly covering the wire-terminal connection section 16 is completed. In other words, the manufacturing of the wire-equipped terminal 1 is completed.

<Summary of the Wire-Equipped Terminal 1 and the Advantages of the Manufacturing Method>

As described above referring to FIGS. 1 to 7A, the wire-equipped terminal 1 includes the aluminum wire 2 and the crimp terminal 3. The aluminum wire 2 includes the conductor 5 made of aluminum or an aluminum alloy and the insulating resin cover 6 for covering the conductor 5. The exposed conductor section 7 is formed by removing the resin cover 6 of the aluminum wire 2 (at the wire processing step S1). On the other hand, the crimp terminal 3 has the caulking section 9 serving as a crimping portion, and the pair of conductor caulking pieces 14 and the pair of cover caulking pieces 15 are formed at the caulking section 9. In the wire-equipped terminal 1, the caulking section 9 is crimped to the exposed conductor section 7, whereby the wire-terminal connection section 16 is formed (at the wire-terminal connecting step S2). The anti-corrosion material 20 is then supplied so as to cover the wire-terminal connection section 16 (at the anti-corrosion material supplying step S3), and the supplied anti-corrosion material 20 is UV cured by the UV light 23, whereby the anti-corrosion section 4 is formed. At the anti-corrosion material supplying step S3, the dispenser 62 for supplying the anti-corrosion material 20 is used. At the anti-corrosion material supplying step S3, after the supply of the anti-corrosion material 20 by the pushing of the piston 65 of the dispenser 62 is ended, the piston 65 is retracted within the range of not allowing the anti-corrosion material 20 to run down from the nozzle 66.

With the present invention, the anti-corrosion material 20 can be prevented from running down. This can eliminate the need for wiping work. Furthermore, since the need for wiping off the anti-corrosion material 20 can be eliminated, material loss can be prevented. Hence, the present invention exhibits the advantages of being capable of improving workability and reducing material loss.

Moreover, with the present invention, the water-repellent function is provided on the surface of the tip end of the nozzle 66 of the dispenser 62 that is used in the anti-corrosion material supplying step S3 (the water-repellent processing section 67 is formed), whereby liquid buildup of the anti-corrosion material 20 can be prevented. That is to say, the need for wiping off the liquid buildup can be eliminated, whereby material loss can be prevented. Hence, similarly to the above description, the present invention exhibits the advantages of being capable of improving workability and reducing material loss. In addition, the present invention can stabilize the supply amount of the anti-corrosion material 20 to the wire-terminal connection section 16 by preventing the liquid buildup of the anti-corrosion material 20, thereby exhibiting the advantage of being capable of maintaining the quality of the formed anti-corrosion section 4 constant.

### <Modification>

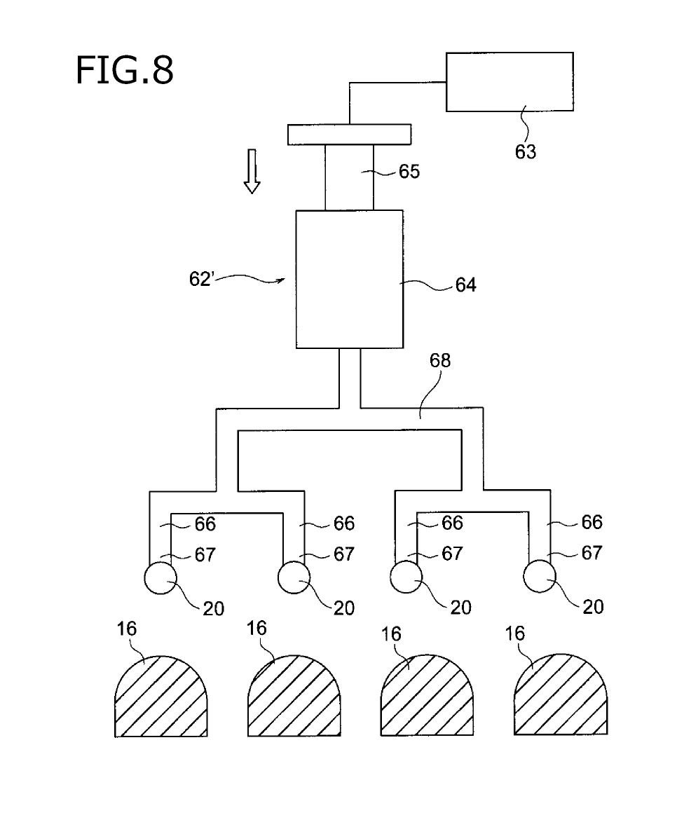

FIG. 8 is a view showing a modification of the dispenser. A dispenser 62′ serving as a modification has a syringe 64, a piston 65 and a plurality of nozzles 66. The plurality of nozzles 66 is connected to the syringe 64 via a nozzle branching section 68. Although the number of the nozzles 66 is four in FIG. 8 (four-way branched), the number of the nozzles 66 is not limited to four, and the number may be eight (eight-way branched) or 16 (16-way branched). The dispenser 62′ has a structure in which the four nozzles 66 discharge an equal amount of the anti-corrosion material 20 simultaneously when the piston 65 of the dispenser 62′ is pushed.

With the present invention in the case that the dispenser 62′ having the above-mentioned structure is adopted, when the piston 65 is pushed, the four nozzles 66 discharge an equal amount of the anti-corrosion material 20 simultaneously as described above, whereby four anti-corrosion sections 4 can be formed at a time. In other words, the four anti-corrosion sections 4 can be formed without increasing the facility for supplying the material. Consequently, the present invention exhibits the advantage of being capable of contributing to the improvement in productivity.

Here, the details of the above embodiments are summarized as follows.

A method for manufacturing a terminal fitting with an electric wire, comprising:
forming a wire-terminal connection section by connecting a terminal fitting to an exposed conductor section of an electric wire in which a resin cover is removed from the electric wire to expose a conductor of the electric wire;
supplying a sealing material from a nozzle of a dispenser to the wire-terminal connection section to form a sealing section that covers the wire-terminal connection section,
wherein in a process of supplying the sealing material, after the supply of the sealing material by pushing of a piston of the dispenser is completed, the piston is retracted within a range of not allowing the sealing material to run down from the nozzle.

By the above method, after the supply of the sealing material is completed, the piston of the dispenser is retracted, whereby a suction action is exerted and the sealing material is prevented from running down.

For example, a surface on a tip end side of the nozzle of the dispenser is subjected to water-repellent processing.

By the above method, at least the surface on the tip end side of the nozzle of the dispenser is provided with the water-repellent processing (water-repellent function), whereby liquid buildup (wetting-up) of the sealing material is prevented by the function.

For example, the dispenser has the nozzle and another nozzle, and an equal amount of the sealing material is simultaneously discharged from each of the nozzle and the another nozzle when the piston is pushed.

By the above method, the dispenser is structured so as to cause the plurality of nozzles to discharge an equal amount of the sealing material simultaneously when the piston is pushed, whereby a plurality of sealing sections can be formed at a time.

In a case that objects to be processed are limited such that the electric wire is an aluminum wire, that the terminal fitting is made of a metal different from the material of the aluminum wire, that the sealing material is an anti-corrosion material, and that the sealing section is an anti-corrosion section, the above method is characterized as described below. That is to say, “A method for manufacturing a terminal fitting with an electric wire, comprising: forming a wire-terminal connection section by connecting a terminal fitting whose base material is made of copper or a copper alloy to the position of an exposed conductor section formed by removing the insulating resin cover of an electric wire having a conductor made of aluminum or an aluminum alloy and the insulating resin cover for covering the conductor and further forming an anti-corrosion section for covering the wire-terminal connection section, wherein a dispenser is used at anti-corrosion material supplying step for supplying an anti-corrosion material to the wire-terminal connection section, and after the supply of the anti-corrosion material by the pushing of the piston of the dispenser is ended, the piston is retracted within the range of not allowing the anti-corrosion material to run down from the nozzle.”

Furthermore, in the case that objects to be processed are limited such that the sealing material is a waterproof material and that the sealing section is a waterproof section, the method is characterized as described below. That is to say, “A method for manufacturing a terminal fitting with an electric wire, comprising the steps of forming a wire-terminal connection section by connecting a terminal fitting to the position of an exposed conductor section formed by removing the resin cover of an electric wire and further forming a waterproof section for covering the wire-terminal connection section, wherein a dispenser is used at waterproof material supplying step for supplying a waterproof material to the wire-terminal connection section, and after the supply of the waterproof material by the pushing of the piston of the dispenser is ended, the piston is retracted within the range of not allowing the waterproof material to run down from the nozzle.”

With the above method, in the sealing material supplying step for supplying the sealing material to the wire-terminal connection section, after the supply of the sealing material by the dispenser that is used in the process is completed, the piston of the dispenser is retracted to prevent the sealing material from running down, thereby eliminating the need for wiping work. Furthermore, since the need for wiping off the sealing material is eliminated, material loss does not occur. Hence, the present invention exhibits the advantages of being capable of improving workability and reducing material loss.

With the above method, the surface of the tip end of the nozzle of the dispenser that is used in the sealing material supplying step is provided with the water-repellent function, whereby liquid buildup of the sealing material can be prevented. In other words, the need for wiping off the liquid buildup is eliminated, whereby material loss does not occur. Hence, the method exhibits the advantages of being capable of improving workability and reducing material loss. In addition, the present invention stabilizes the supply amount of the sealing material to the wire-terminal connection section by preventing the liquid buildup of the sealing material, thereby exhibiting the advantage of being capable of maintaining the quality of the formed sealing section constant.

The dispenser that is used in the sealing material supplying step has the nozzles being plural in number and causes the plurality of nozzles to discharge an equal amount of the sealing material simultaneously when the piston is pushed, whereby the present invention can exhibit the advantage of being capable of forming a plurality of sealing sections at a time. In other words, the plurality of sealing sections can be formed without increasing the facility for supplying the material. The present invention thus exhibits the advantage of being capable of contributing to the improvement in productivity.

The present invention can be changed variously without departing from the gist of the present invention as a matter of course.

What is claimed is:

1. A method for manufacturing a terminal fitting with an electric wire, comprising:
forming a wire-terminal connection section by connecting a terminal fitting to an exposed conductor section of an electric wire in which a resin cover is removed from the electric wire to expose a conductor of the electric wire;
supplying a sealing material from a nozzle of a dispenser to the wire-terminal connection section to form a sealing section that covers the wire-terminal connection section,
wherein in a process of supplying the sealing material, after the supply of the sealing material by pushing of a piston of the dispenser is completed, the piston is retracted within a range of not allowing the sealing material to run down from the nozzle.

2. The method according to claim 1, wherein a surface on a tip end side of the nozzle of the dispenser is subjected to water-repellent processing.

3. The method according to claim 1, wherein the dispenser has the nozzle and another nozzle; and
wherein an equal amount of the sealing material is simultaneously discharged from each of the nozzle and the another nozzle when the piston is pushed.
